(19) United States
(12) Patent Application Publication
(10) Pub. No.: US 2025/0378608 A1
(43) Pub. Date: Dec. 11, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TATSUYA YAMAMOTO, Tokyo (JP)

(21) Appl. No.: 19/225,074

(22) Filed: Jun. 2, 2025

(30) Foreign Application Priority Data
Jun. 5, 2024 (JP) 2024-091739

(51) Int. Cl. G06T 11/60; G06F 3/0482; G06F 3/04845; G06F 3/14

(52) U.S. Cl. CPC G06T 11/60; G06F 3/0482; G06F 3/04845; G06F 3/14

(57) ABSTRACT

An information processing apparatus that manages captured images of a user includes: a selection unit configured to select the captured image meeting a specific condition from among the managed captured images; a modification unit configured to modify the specific condition based on an instruction by a user; and a display control unit configured to perform a process of displaying a list screen of the captured image selected as meeting the specific condition, and the list screen is displayed such that the captured image selected as meeting the specific condition before the modification and the captured image selected as meeting the specific condition after the modification are identifiable.

### CROSS REFERENCE TO PRIORITY APPLICATION

This application claims the benefit of Japanese Patent Application No. 2024-091739, filed Jun. 5, 2024, which is hereby incorporated by reference herein in its entirety.

### BACKGROUND

### Field of the Technology

The present disclosure relates to a process of selecting and displaying images.

### Description of the Related Art

There is known a method of selecting images meeting a predetermined condition from among multiple images and displaying the selected images.

Japanese Patent Laid-Open No. 2010-199633 proposes a method of displaying a list of captured images meeting a condition selected by a user.

### SUMMARY

An information processing apparatus of the present disclosure is an information processing apparatus that manages captured images of a user, the information processing apparatus including: a selection unit configured to select the captured image meeting a specific condition from among the managed captured images; a modification unit configured to modify in the specific condition, based on an instruction by a user; and a display control unit configured to perform a process of displaying a list screen of the captured image selected as meeting the specific condition, and the list screen is displayed such that the captured image selected as meeting the specific condition before the modification and the captured image selected as meeting the specific condition after the modification are identifiable.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a configuration of an image management system;

FIG. 2 is a diagram illustrating an example of a configuration of hardware of an image management apparatus;

FIG. 3 is a diagram illustrating an example of a functional configuration of the image management apparatus;

FIG. 4 is a diagram illustrating an example of an image management table;

FIGS. 5A and 5B are diagrams illustrating examples of a sorting rule management table;

FIG. 6 is a flowchart for explaining a sorting process;

FIGS. 7A and 7B are diagrams illustrating examples of a sorting result management table;

FIG. 8 is a flowchart for explaining a process of generating a list screen of sorting results;

FIG. 9 is a diagram illustrating an example of the list screen of the sorting results;

FIG. 10 is a diagram illustrating an example of the list screen of the sorting results;

FIGS. 11A and 11B are diagrams illustrating examples of the sorting result management table;

FIG. 12 is a flowchart for explaining a resorting process;

FIG. 13 is a diagram illustrating an example of the list screen of the sorting results; and

FIG. 14 is a diagram illustrating an example of the list screen of the sorting results.

### DESCRIPTION OF THE EMBODIMENTS

A technique of the present disclosure is explained below in detail based on embodiments with reference to the attached drawings. Note that configurations described in the following embodiments are merely examples, and the technique of the present disclosure is not limited to the illustrated configurations.

There is an event such as a wild bird photo session which is held every month, and there is a case where images captured in the event of each month are desired to be collectively displayed in a list. In this case, for example, a condition A for selecting the images captured in the event held in January is generated, and the images meeting this condition A are selected. Next, the condition A is modified such that the images captured in the event held in February are selected, and the captured images meeting the condition A after the modification are selected. Then, the list of captured images meeting the condition A is displayed, and the images captured in the events held in January and February are thereby assumed to be collectively displayed in a list. However, in the case where a list as described above is displayed, the captured images meeting the condition before the modification and the captured images meeting the condition after the modification coexist in a mixed manner, and there is a possibility that the user has difficulty identifying the captured images meeting the condition after the modification from the list.

In order to suppress the difficulty, according to the technique of the present disclosure, the user can identify the images selected in the condition after modification also in the case where the images selected in the condition before the modification and the images selected in the condition after the modification are collectively displayed.

### Embodiment 1

In the present embodiment, explanation is given of a method of displaying a list of images sorted from an image group based on a sorting rule.

### [System Configuration]

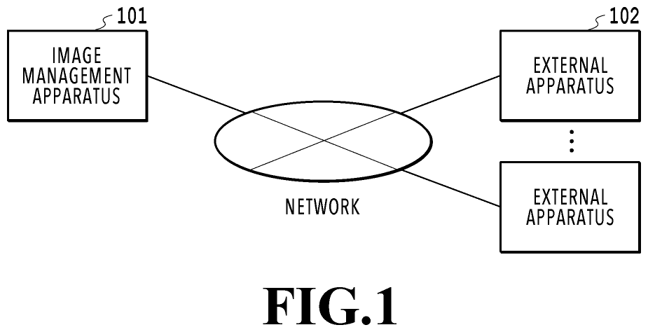

FIG. 1 is a diagram illustrating an example of a configuration of an image management system according to the present embodiment. The image management system includes an image management apparatus 101 and external apparatuses 102.

The image management apparatus 101 is an information processing apparatus that manages image data of a user. The image management apparatus 101 is an apparatus that receives the image data transmitted from the user and provides a service of saving the received image data. For example, the image management apparatus 101 receives data of captured images that are transmitted from an imaging apparatus of the user connected to a network and that are obtained by being captured by the imaging apparatus.

The user can use the service provided by the image management apparatus 101 by creating an account for the service provided by the image management apparatus 101. For example, the user can create the account via a terminal connected to the network. The terminal is a PC, a tablet, a smartphone, a camera, or the like. A web application that operates in a browser is installed in the terminal. The user who has the account for the service provided by the image management apparatus 101 can perform browsing of a list of image files of the user saved in the image management apparatus 101, deletion of the image files, and the like via the web application. Moreover, the user can change settings relating to the service provided by the image management apparatus 101 via the web application.

The external apparatuses 102 are information processing apparatuses that provide web services such as a storage service, an editing service, and a micro-blog service. Services provided by the external apparatuses 102 are referred to as external services. Although explanation is given assuming that the image management system includes various external apparatuses that each provide an external service, the number of external services is not limited.

The network is, for example, a local area network (LAN), the Internet, or the like. Since the image management apparatus 101, the external apparatuses 102, and the terminal are connected to one another via the network, these apparatuses are configured to be communicable with one another. Note that the image management apparatus 101 does not have to be connected to the network, and does not have to be connected to the external apparatuses 102.

### [Hardware Configuration]

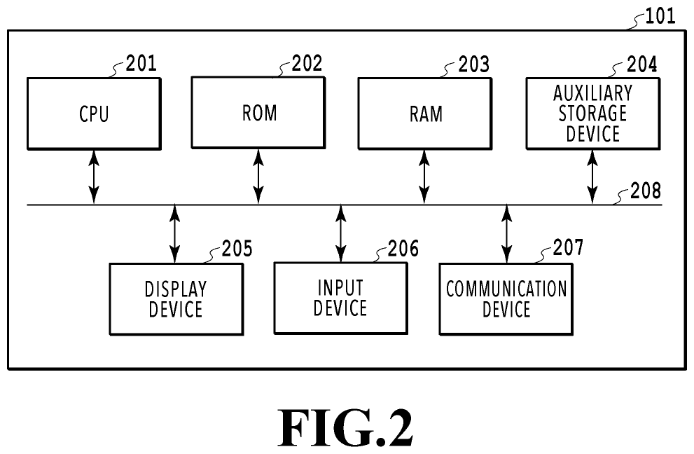

FIG. 2 is a hardware configuration of the image management apparatus 101. The image management apparatus 101 includes a CPU 201, a ROM 202, a RAM 203, an auxiliary storage device 204, a display device 205, an input device 206, a communication device 207, and a system bus 208.

The central processing unit (CPU) 201 is a central processing unit that performs various processes such as calculation and logical determination and controls various component elements connected to the system bus 208.

The read-only memory (ROM) 202 is a program memory that stores programs for performing various processes, control, and the like executed by the CPU 201. For example, the ROM 202 functions as a program memory by loading the programs stored in the ROM 202 onto the RAM 203.

The random access memory (RAM) 203 is a memory used as a temporary storage area such as a main memory and a work area of the CPU 201. Moreover, the CPU 201 writes an execution result of each process into the RAM 203. The CPU 201 reads and executes the programs stored in the ROM 202 to execute processes according to each of flowcharts to be described later.

The auxiliary storage device 204 is a storage device in which electronic data and programs are saved so as not to be erased even if power is turned off. Moreover, a result of each process executed by the CPU 201 is saved in the auxiliary storage device 204. The auxiliary storage device 204 may be used as a program memory by loading the programs stored in the auxiliary storage device 204 onto the RAM 203.

The auxiliary storage device 204 is implemented by, for example, a medium (recording medium) and an external storage drive for achieving access to this medium. Such a medium is, for example, a flash memory, a USB memory, a solid state drive (SSD) memory, a hard disk drive (HDD), a flexible disk (FD), a CD-ROM, a DVD, an SD card, or the like. Functions of the auxiliary storage device 204 may be implemented by a server apparatus or the like connected to the network. The auxiliary storage device 204 may be a device configured to be unremovable from the CPU 201 such as, for example, a solid state drive (SSD) memory included in a main body. The present embodiment is explained below assuming that the auxiliary storage device 204 is the solid state drive (SSD) memory included in the main body.

The display device 205 is a display unit such as, for example, a liquid crystal display or an organic EL display. A screen including images, characters, figures, and the like is displayed on the display device 205 by a process of the CPU 201. The input device 206 is an operation unit that is, for example, a button and a mouse and that receives various operations by the user. The input device 206 may be a device that is attached to the display device 205 and that senses operations of the user such as a pressure touch panel or an electrostatic touch panel. In this case, a light pen and the like may be included in the input device 206. The display device 205 and the input device 206 may not be present inside the image management apparatus 101. The display device 205 may be present as an external device connected to the image management apparatus 101 wirelessly or via a wire. Moreover, the input device 206 may be present as an external device such as a mouse connected to the image management apparatus 101 wirelessly or via a wire. The CPU 201 operates also as a display control unit that controls the display device 205 and as an operation control unit that controls the input device 206.

The communication device 207 is a device for performing wireless or wired bidirectional communication between the image management apparatus 101 and each of the external apparatuses of the image management apparatus 101, a communication apparatus, an external storage device, and the like by means of a publicly-known communication technique. The system bus 208 transmits information by connecting the units of the image management apparatus 101 to one another.

### [Functional Configuration]

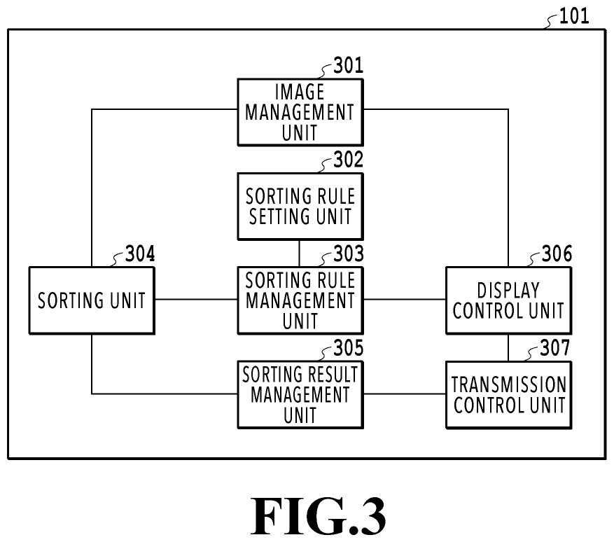

FIG. 3 is a block diagram illustrating an example of a functional configuration of the image management apparatus 101. The image management apparatus 101 includes an image management unit 301, a sorting rule setting unit 302, a sorting rule management unit 303, a sorting unit 304, a sorting result management unit 305, a display control unit 306, and a transmission control unit 307.

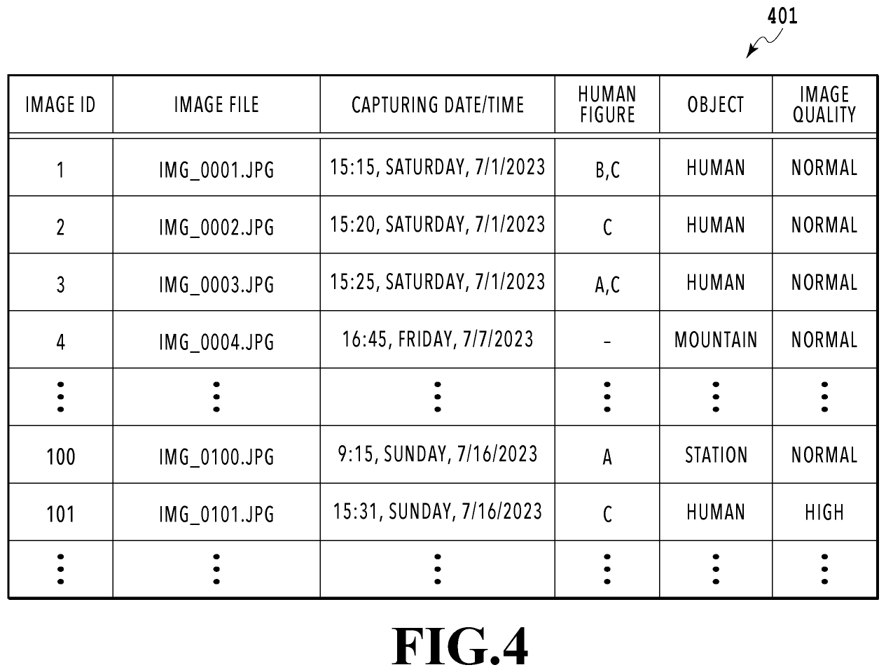

The image management unit 301 manages information on the images (image files) of the user saved in the image management apparatus 101. In the present embodiment, the image management unit 301 manages the information on the image for each user by using an image management table 401 (see FIG. 4) for managing the information on the images of the user.

The sorting rule setting unit 302 generates a sorting rule. The image management apparatus 101 of the present embodiment has a function of selecting images meeting the sorting rule from among the saved images. The process of determining whether each image meets the sorting rule or not is also referred to as “sorting process”, and execution of the sorting process is also referred to as “sort”. The sorting rule setting unit 302 generates this sorting rule. The sorting rule may be generated based on a condition designated by the user, or may be automatically generated based on a result of analysis performed on the saved images. The sorting rule setting unit 302 also functions as a modification unit that modifies (changes) the generated sorting rule based on an instruction of the user or the like.

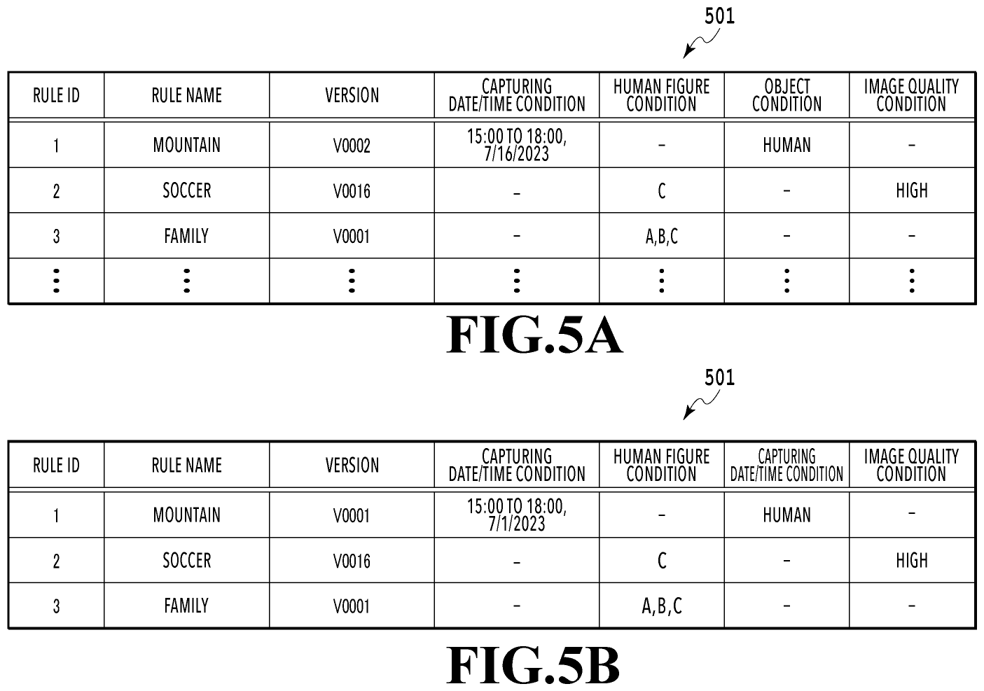

The sorting rule management unit 303 manages the sorting rule generated by the sorting rule setting unit 302 in association with version information. In the present embodiment, the sorting rule management unit 303 manages the sorting rule by using a sorting rule management table 501 (see FIGS. 5A and 5B) to be described later.

The sorting unit 304 functions as a selection unit that executes the sorting process on each of images being processing targets and selects images meeting the sorting rule. Details are described later.

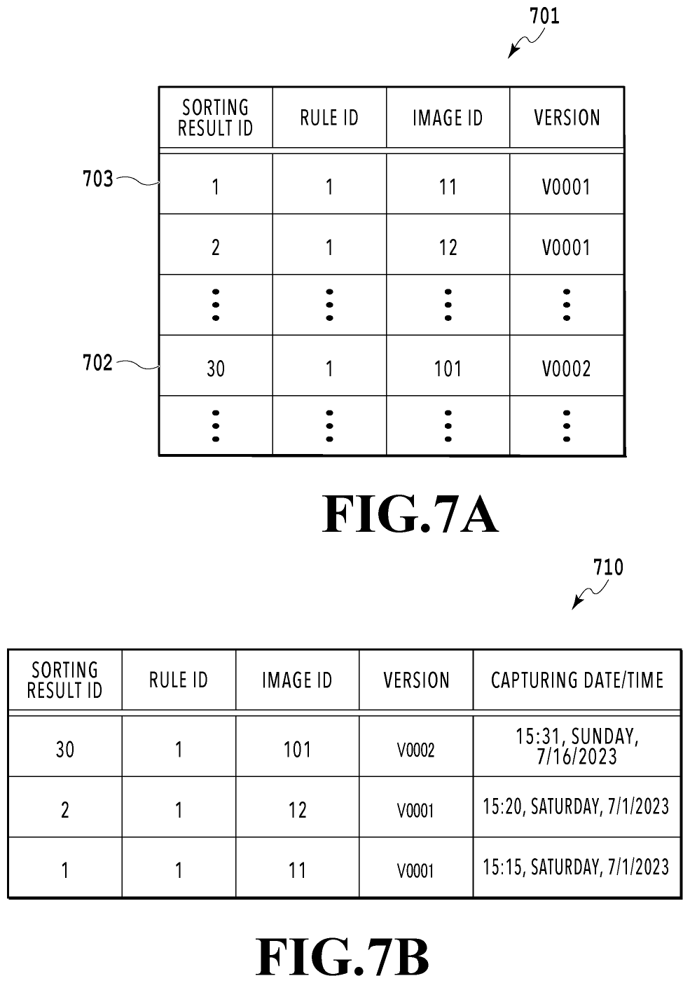

The sorting result management unit 305 manages a result obtained in the case where the sorting unit 304 performs the sorting process. In the present embodiment, the sorting result management unit 305 manages a sorting result by using a sorting result management table 701 (see FIGS. 7A and 7B) to be described later.

The display control unit 306 performs control for displaying a processing result and the like to the user.

The transmission control unit 307 performs a process of transmitting data of images selected by the user to a predetermined folder in the external apparatuses 102 or the auxiliary storage device 204 via a communication device, and causes the transmitted data of the images to be saved in the transmission destination. Note that, in Embodiment 1, the transmission control unit 307 may not be included in the configuration of the image management apparatus 101.

The CPU 201 of the image management apparatus 101 implements the functional units illustrated in FIG. 3 by loading programs stored in the auxiliary storage device 204 and the like onto the RAM 203, and executing processes. Alternatively, for example, in the case where hardware is configured as an alternative of software processes using the CPU 201, computation units and circuits corresponding to processes of the respective functional units of FIG. 3 may be configured.

### [Regarding Image Management Table]

FIG. 4 is a diagram illustrating an example of the image management table for managing the data of images (image files) of the user saved in the image management apparatus 101. In the image management table 401, a file name of each of the images of the user saved in the image management apparatus 101 and values indicating attribute information of this image are saved in the same row while being associated with a value of an image ID uniquely identifying this image.

In the present embodiment, “capturing date/time” indicating date and time of capturing of the image, “human figure”, “object”, and “image quality” are assumed to be managed as the attribute information of the image. The attribute information of the image is an example, and is not limited to these pieces of information.

The attribute information of “human figure” is information indicating which human figure the human figure included in the image is, and a label identifying the human figure is held in a “human figure” column of the image management table 401.

The attribute information of “object” is information indicating a category of the object included in the image, and a label indicating the object category is held in a “object” column of the image management table 401. The object category includes, for example, human, living creature, animal, dog, cat, bird, plant, vehicle, car, train, airplane, food, sports, building, mountain, sea, nightscape, stationary object, and the like.

The attribute information of “image quality” is information indicating the image quality of the image, and at least “high”, “normal”, or “low” is held in an “image quality” column of the image management table 401 as a value indicating the image quality of the image.

In the case where the image management apparatus 101 receives an image, image analysis such as a process of extracting an object included in the image is performed on the received image. Values obtained by analyzing the target image are held as the values held in the respective columns of “human figure”, “object”, and “image quality”.

### [Regarding Sorting Rule Management Table]

FIGS. 5 and 5B are diagrams illustrating examples of the sorting rule management table for managing the sorting rule. In the present embodiment, since various sorting rules may be generated, already-generated sorting rules are managed in the sorting rule management table 501. In each row of the sorting rule management table 501, for each value of the rule ID uniquely identifying the sorting rule, a rule name, a version, and values of sorting items of the sorting rule indicated by the rule ID are held in the same row while being associated with one another. The rule name is the name of the sorting rule.

The sorting items are items used to determine whether the target image meets the sorting rule or not, and four items of “capturing date/time condition”, “human figure condition”, “object condition”, and “image quality condition” are assumed to be the sorting items in the present embodiment. These sorting items correspond to “capturing date/time”, “human figure”, “object”, and “image quality” that are the attribute information of the image, respectively. Values do not have to be set for all of the four sorting items in the sorting rule, and a value is set for at least one of the sorting items.

The sorting item “capturing date/time condition” is a sorting item for sorting an image by performing comparison with the value of “capturing date/time” that is the attribute information of the image. In the case where the image is sorted by “capturing date/time”, values indicating a range of the capturing date/time of the images to be selected are held in the “capturing date/time condition”. For example, in order to select images captured in a range of 15:00 to 18:00, Jul. 28, 2023, the sorting rule is generated or updated such that “15:00 to 18:00, Jul. 28, 2023” is held in the “capturing date/time condition”.

The sorting item “human figure condition” is a sorting item for sorting a target image by performing comparison with the value of “human figure” that is the attribute information of the target image. In the case where images including a predetermined human figure are desired to be selected, a label indicating the predetermined human figure is held in the “human figure condition”. For example, in order to select images including a human figure C, the sorting rule is generated or updated such that a label “C” indicating the human figure C is held in the “human figure condition”.

The sorting item “object condition” is a sorting item for sorting a target image by performing comparison with the value of “object” that is the attribute information of the target image. In the case where images including a predetermined object category are desired to be selected, a label indicating the predetermined object category is held in the “object condition”. For example, in order to select images including a mountain, the sorting rule is generated or updated such that “mountain” is held in the “object condition”.

The sorting item “image quality condition” is a sorting item for selecting a target image by performing comparison with the value of “image quality” that is the attribute information of the target image. In the case where images of predetermined image quality or higher are desired to be sorted, a label indicating the predetermined image quality is held in the “image quality condition”. For example, in order to select images whose image quality is normal or higher, the sorting rule is generated or updated such that “normal” is held in the “image quality condition”.

A value indicating a version that is revision information of the sorting rule is held in the “version”. In the sorting rule, a value of a sorting item is modified based on an instruction of the user in some cases. In the case where the value of the sorting item is modified, the value of the “version” column in the sorting rule in which the value of the sorting item is modified is updated to a value incremented from the current value by 1. For example, since the version of the sorting rule with the rule ID of “1” in FIG. 5A is “V0002”, this means that the sorting rule with the rule ID of “1” is a sorting rule in which the value of the sorting item has been modified once. The version managed in the sorting rule management table 501 is referred to as latest version in some cases.

The sorting rule management table 501 of FIG. 5B is an example of the sorting rule management table saved before modification of the sorting rule with the rule ID of “1”. “V0001” is held in the “version” column of the sorting rule, immediately after this sorting rule is generated. Then, the value of the capturing date/time condition in the sorting rule with the rule ID of “1” is modified. Accordingly, the version is updated in the sorting rule management table 501 of FIG. 5B, and “V0002” is held in the “version” column of the sorting rule with the rule ID of “1”.

Note that the version information held in the “version” column may be information on the date and time at which the sorting rule is set or modified. As described above, in the present embodiment, since the sorting rule is managed while being associated with the version information, a sorting result to be described later can also have the version information.

### [Flow of Sorting Process]

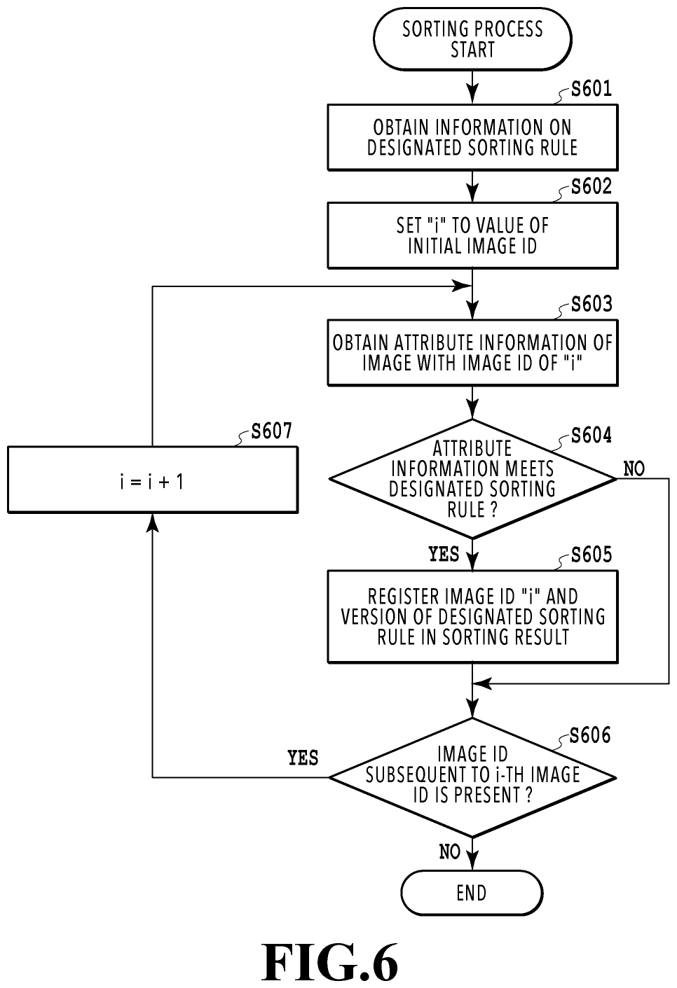

FIG. 6 is a flowchart for explaining details of the sorting process. In a series of processes illustrated in the flowchart of FIG. 6, the CPU 201 executes the processes of the respective steps by loading program codes stored in the ROM 202 or the auxiliary storage device 204 onto the RAM 203 and executing the program codes to implement functional units. Alternatively, the functions of some or all of the steps in FIG. 6 may be implemented by hardware such as an ASIC or an electronic circuit. Sign “S” in explanation of each process means step in the flowchart, and the same applies to the following flowcharts.

The flowchart of FIG. 6 is started in the case where the user designates a rule ID of a sorting rule at an arbitrary timing, and instructs the image management apparatus 101 to execute the sorting process. Alternatively, the flowchart of FIG. 6 may be started every time images are added to the image management apparatus 101, at a timing of reception of the last one of the added images. As another alternative, the flowchart of FIG. 6 may be regularly executed every fixed time period. In the case where the flowchart of FIG. 6 is started independent of the user instruction, for example, the CPU 201 designates the rule ID from the top of the sorting rule management table 501, and executes the flowchart of FIG. 6. Then, in the case where the flowchart of FIG. 6 is completed, the CPU 201 designates the next rule ID in the sorting rule management table 501, and starts the flowchart of FIG. 6. This process may be repeated until all rule IDs held in the sorting rule management table 501 are designated and the flowchart of FIG. 6 is completed.

In S601, the CPU 201 obtains the value of the rule ID of the designated sorting rule, and obtains the values of the sorting items and the value of the version associated with the obtained value of the rule ID in the sorting rule management table 501.

In S602, the CPU 201 sets a variable “i”. The following steps S603 to S607 are a loop process in which an image corresponding to the variable i among the images of the user managed in the image management table 401 is set as the target of the sorting process.

In the case where the sorting process is performed for the first time, in S601, the CPU 201 sets the variable i to 1 such that all images managed in the image management table 401 are set as the targets of the sorting process.

In the present embodiment, the sorting results of the images that have been the target of the sorting process according to the designated sorting rule in the past are assumed to be managed while being unchanged. Accordingly, in S602, the CPU 201 is assumed to set the variable i such that the images that have been the targets of the sorting process according to the designated sorting rule in the past are not set as the targets of the current sorting process. Specifically, the variable i is set to the value of the image ID of the first image among images added after execution of the sorting process according to the designated sorting rule. For example, in the case where the sorting process has been performed on images up to an image with an image ID of “29” in the sorting process executed in the immediately-previous operation, in S601, the CPU 201 sets the variable i to “30” in the current sorting process.

In S603, the CPU 201 obtains the attribute information of the image associated with the image ID with the value of “i”, from the image management table 401. Specifically, the attribute information of the image that is the target of the current sorting process is obtained from the image management table 401.

In S604, the CPU 201 determines whether the image being the target of the current sorting process meets the designated sorting rule or not.

Specifically, the CPU 201 selects the determination target sorting item from among the sorting items forming the designated sorting rule. Note that, since there is a case where no value is held in the sorting item as described above, the CPU 201 selects the determination target sorting item from among the sorting items for which values are held. Then, the CPU 201 determines whether the attribute information of the image being the target of the sorting process satisfies the condition indicated by the determination target sorting item or not. The CPU 201 repeats this determination process while changing the determination target sorting item.

For example, assume that the image currently being the target of the sorting process is an image with an image ID of “2” in FIG. 4. Moreover, assume that the rule ID of the designated sorting rule is “2”. In this case, as illustrated in the sorting rule management table 501 of FIG. 5A, the sorting items that may be the determination target sorting items are “human figure condition” and “image quality condition”. Assume that “human figure condition” is selected first as the determination target out of these items. In this case, the CPU 201 compares “C” of the attribute information “human figure” in the row of the image ID of “2” in FIG. 4 with “C” of the sorting item “human figure condition” in the row of the rule ID of “2”, and determines that the condition of determination target sorting item is satisfied. Next, the sorting item “image quality condition” is selected as the determination target. In this case, the CPU 201 compares “normal” in the attribute information “image quality” in the row of the image ID of “2” with “high” of the determination target sorting item “image quality condition”, and determines that the condition of the determination target sorting item is not satisfied. In the case where the CPU 201 determines that the conditions of all determination target sorting items are satisfied, the CPU 201 determines that the image being the target of the sorting process meets the designated sorting rule. Accordingly, the CPU 201 determines that the image with the image ID of “2” does not meet the sorting rule with the rule ID of “2”. Meanwhile, the CPU 201 determines that an image with an image ID of “101” meets the sorting rule with the rule ID of “2”.

In the case where the CPU 201 determines that the image being the target of the sorting process meets the designated sorting rule in S604 (YES in S604), the CPU 201 proceeds to S605.

In S605, the CPU 201 saves the value of the rule ID of the designated sorting rule, the value of the image ID of the image currently being the target of the sorting process, and the value of the version obtained in S601 as the sorting result in association with one another. For example, the sorting result is managed in the sorting result management table 701 (see FIGS. 7A and 7B) to be described later, in association with a value of a sorting result ID for identifying the sorting result. Then, the CPU 201 causes the process to proceed to S606.

Meanwhile, in the case where the CPU 201 determines that the image being the target of the sorting process does not meet the designated sorting rule (NO in S604), the CPU 201 skips S605, and causes the process to proceed to S606.

In S606, the CPU 201 determines whether there is an image ID of a value subsequent to the current “i” in the image management table 401. In the case where there is the subsequent image ID (YES in S606), the CPU 201 proceeds to S607. In S607, the CPU 201 adds one to the current i to increment the variable i, and thereby changes the image being the target of the sorting process. Then, the CPU 201 returns to S603.

In the case where the CPU 201 determines that there is no subsequent image ID in the image management table 401 (NO in S606), the CPU 201 terminates the sorting process according to the designated sorting rule.

### [Regarding Sorting Result Table]

FIG. 7A is a diagram illustrating an example of the sorting result management table. In the sorting result management table 701, each sorting result is associated with a value of a sorting result ID uniquely identifying the sorting result. The sorting result is information in which the value of the rule ID indicating the sorting rule, the value of the image ID indicating the image determined to meet this sorting rule, and the value of the version of this sorting rule are associated with one another.

The value of the associated version in the sorting result is a value indicating the version of the sorting rule at a time point at which the sorting process is performed. For example, assume that the latest version of the sorting rule with the rule ID of “1” is “V0002”. A sorting result of a row 703 in which “V0001” is held in the version column in FIG. 7A means that a row 703 holds a result of sorting according to the previous version of the sorting rule before the modification. Specifically, it is found that the image with the image ID of “11” is an image determined to meet the sorting rule before the modification. Moreover, a sorting result of a row 702 in which “V0002” is held in the version column means that the row 702 holds a result of sorting according to the latest version of the sorting rule. Specifically, it is found that the image with the image ID of “101” is an image determined to meet the latest version of the sorting rule.

As described above, in the present embodiment, the version of the sorting rule used in the sorting process is managed as the sorting result in association with the sorting rule used in the sorting process. Moreover, also in the case where the sorting rule is modified and the version is updated, the result of sorting in the previous version is managed to be held in the sorting result management table 701.

### [Display of List of Sorting Results]

The image management apparatus 101 can display a screen expressing the sorting results managed by the sorting result management table 701 to the user. For example, in the case where the user designates a certain sorting rule, the image management apparatus 101 can display a list of thumbnails of images determined to meet the designated sorting rule among the saved images of the user, to the user.

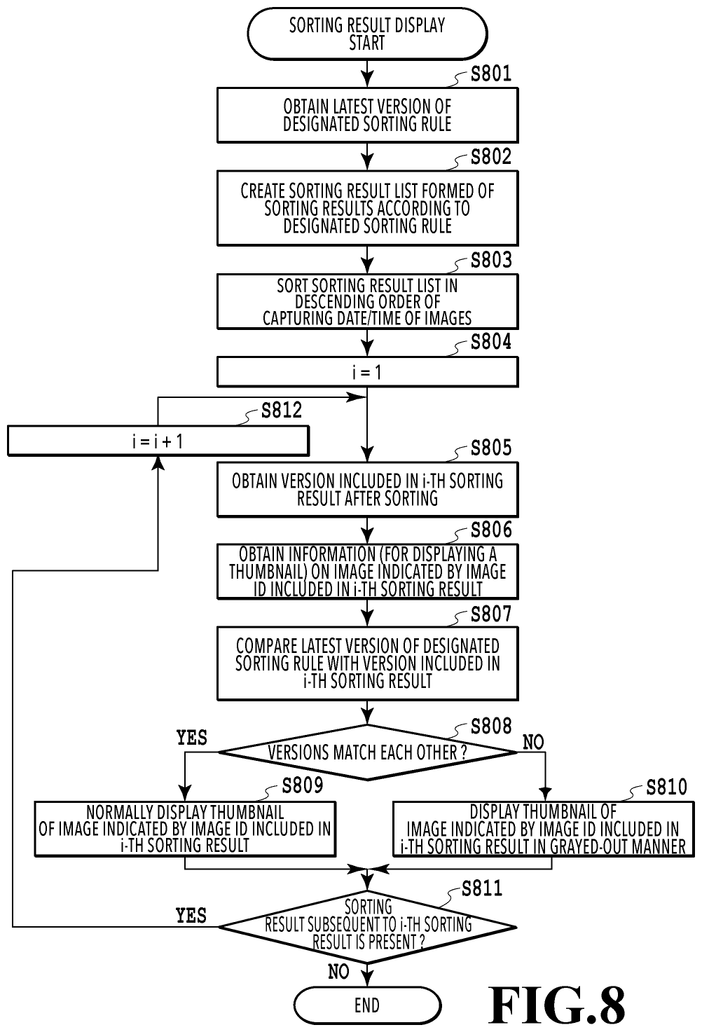

FIG. 8 is a flowchart for explaining a flow of processes for displaying the thumbnail list of images meeting the designated sorting rule. In a series of processes illustrated in the flowchart of FIG. 8, the CPU 201 executes the processes of the respective steps by loading program codes stored in the ROM 202 or the auxiliary storage device 204 onto the RAM 203 and executing the program codes to implement functional units. Alternatively, some or all of the functions of the steps in FIG. 8 may be implemented by hardware such as an ASIC or an electronic circuit.

The flowchart of FIG. 8 is started, for example, in the case where the user designates an arbitrary sorting rule and instructs the image management apparatus 101 to display the sorting results.

In S801, the CPU 201 obtains the value of the version associated with the rule ID indicating the sorting rule designated by the user, from the latest sorting rule management table 501. Specifically, the value indicating the latest version of the designated sorting rule is obtained.

In S802, the CPU 201 obtains the sorting results (rows) in which the rule ID with the same value as the rule ID indicating the designated sorting rule is held, from the sorting result management table 701, and creates a list of obtained sorting results.

For example, assume that the currently-saved sorting result management table 701 is in the state of FIG. 7A and the rule ID of the designated sorting rule is “1”. In this case, there is generated a sorting result list 710 as illustrated in FIG. 7B formed of rows in which “1” is held in the column of rule ID and in which the sorting result IDs of “1”, “2”, and “30” are held.

In S803, the CPU 201 sorts the sorting result list generated in S802 in the descending order of capturing date/time of the images.

For example, the CPU 201 obtains the value of the capturing date/time associated with each of the values of the image IDs included in the sorting result list 710, from the image management table 401. Then, as illustrated in FIG. 7B, the CPU 201 causes the obtained capturing date/time to be held in a corresponding one of the rows of the sorting result list. Sorting the rows in the descending order of the capturing date/time in this state causes the sorting result list 710 to be sorted in the descending order of the capturing date/time.

In S804, the CPU 201 initializes an variable i to 1. The following steps S805 to S812 are a loop process in which a row (sorting result) corresponding to the variable i in the sorting result list 710 obtained in S802 and sorted in S803 is the processing target. The variable i is initialized to 1 such that the rows are set as the processing targets from the top row of the sorting result list.

In S805, the CPU 201 obtains the version information held in the processing target sorting result that is the i-th row, from the sorting result list 710 generated in S802.

In S806, the CPU 201 obtains the image ID held in the processing target sorting result that is the i-th row, from the sorting result list 710, and obtains the information on the image indicated by the obtained image ID, from the image management table 401. Note that, in S806, information for displaying a thumbnail of the image indicated by the image ID included in the processing target sorting result is obtained.

In S807, the CPU 201 compares the value indicating the latest version of the designated sorting rule obtained in S801 with the value of the version included in the current processing target sorting result obtained in S805.

In S808, the CPU 201 determines whether the value of the version included in the processing target sorting result is the value of the latest version or not. In the case where the value of the version included in the processing target sorting result obtained in S805 matches the value of the latest version obtained in S801, the CPU 201 can determine that the value of the version included in the processing target sorting result is the value of the latest version.

In the case where the CPU 201 determines that the value of the version included in the processing target sorting result is the value of the latest version (YES in S808), the CPU 201 causes the process to proceed to S809. In S809, the CPU 201 arranges the thumbnail on the screen by using the information obtained in S806, and causes this thumbnail to be normally displayed. Specifically, in order to indicate that the image indicated by the image ID included in the current processing target sorting result is an image sorted according to the latest version of the sorting rule, the CPU 201 causes the thumbnail of this image to be normally displayed.

In the case where the CPU 201 determines that the value of the version included in the processing target sorting result is not the value of the latest version (NO in S808), the CPU 201 causes the process to proceed to S810. In S810, the CPU 201 arranges the thumbnail on the screen by using the information obtained in S806, and causes this thumbnail to be displayed in a grayed-out manner. Specifically, in order to indicate that the image indicated by the image ID included in the current processing target sorting result is an image sorted according to the previous version of the sorting rule, the CPU 201 displays the thumbnail of this image in a grayed-out manner.

In S811, the CPU 201 determines whether there is a row (sorting result) subsequent to the current “i”-th row in the sorting result list 710 generated in S802 and sorted in S803. In the case where the CPU 201 determines that there is the subsequent row (sorting result) (YES in S811), the CPU 201 causes the process to proceed to S812. In S812, the CPU 201 adds 1 to the current i to increment the variable i, and thereby changes the processing target sorting result. Then, the CPU 201 returns to S805.

In the case where the CPU 201 determines that there is no subsequent row (sorting result) (NO in S811), the CPU 201 terminates the screen generation process for displaying the sorting results of the designated sorting rule.

The screen for displaying the sorting results generated as a result of executing the flowchart of FIG. 8 may be displayed on the display device 205, or displayed on a terminal of the user. In the case where the sorting result is displayed on the terminal of the user, the CPU 201 only needs to transmit information for displaying the screen to the terminal of the user.

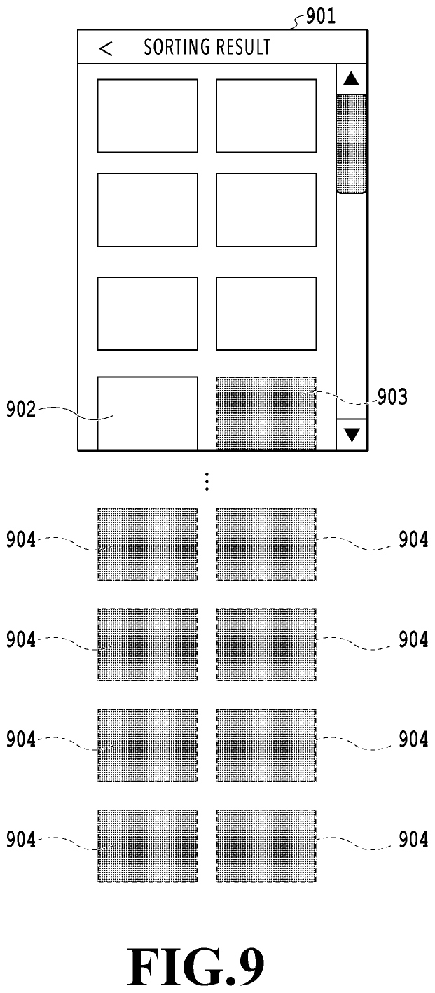

FIG. 9 is a diagram illustrating an example of the screen for presenting the sorting results of the designated sorting rule to the user. A list screen 901 of FIG. 9 is an example of the screen generated as a result of the flowchart of FIG. 8, and is a screen for presenting the list of thumbnails of the images determined to meet the designated sorting rule to the user. The thumbnails included in the list screen 901 include the normally-displayed thumbnails and the thumbnails displayed in a grayed-out manner. A thumbnail 902 is a thumbnail normally displayed as a result of S809, and is a thumbnail indicating the image sorted according to the latest version of the sorting rule. A thumbnail 903 is a thumbnail displayed in a grayed-out manner as a result of S810, and is a thumbnail of the image sorted according to the previous version of the sorting rule. Thumbnails 904 illustrate thumbnails that do not fit into the list screen 901 but are displayed on the list screen 901 in the case where the list screen 901 is scrolled.

As described above, in the present embodiment, an image being a target of a certain sorting process, that is an image being a target of determination of whether the image meets the sorting rule or not is controlled not to be set as the target of the sorting process according to the sorting rule after the modification of the contents of this sorting rule.

Moreover, even in the case where the version of the certain sorting rule is updated in the sorting result management table 701, the sorting result sorted according to the previous version of the certain sorting rule is managed in the sorting result management table as it is. Accordingly, it is possible to collectively display the thumbnails of the image meeting the previous version of the certain sorting rule and the image meeting the latest version of the certain sorting rule in the case where the list of images meeting the certain sorting rule is displayed by using the sorting result management table 701.

Keeping the information on the image meeting the previous version of the sorting rule as described above is preferable for the user in some cases. For example, there is an event A such as a wild bird photo session which is held monthly, and there is a case where the user participates in this event every month to perform photo shooting, and saves images captured in this event in the image management apparatus 101. In the sorting process, the user is assumed to generate the sorting rule as follows in the case of selecting the images captured in the event A. For example, the user is assumed to create individual sorting rules such as a sorting rule 1 in which the capturing date/time is set such that the images captured in the event A held in January are selected and a sorting rule 2 in which the capturing date/time is set such that the images captured in the event A held in February are selected. In this case, there is a possibility that the number of sorting rules increases, and management of the rules becomes cumbersome for the user.

Accordingly, for example, the sorting rule A in which the date and time at which the event of January is held is set in the “capturing date/time condition” is generated to select the images captured in the event A held in January, and the images meeting this sorting rule A are selected. Next, the “capturing date/time condition” of the sorting rule A is modified to the date and time at which the event of February is held to select the images captured in the event held in February, and the captured images meeting the sorting rule A after the modification are selected. Then, the list of the captured images meeting the sorting rule A is displayed, and the images captured in the event A held in January and the event A held in February can be thereby collectively displayed only by generating one sorting rule.

As described above, in the case where images desired to be selected are images of the same theme (for example, event name), modifying one sorting rule is more preferable than generating multiple sorting rules in some cases. In this case, keeping the information on the images meeting the previous version of the sorting rule as in the present embodiment enables displaying of the list of images selected according to the same theme.

Moreover, for example, it is possible to assume a case where the user modifies values of some of sorting items in a certain sorting rule as a trial to check whether the sorting rule after the modification is appropriate or not. In this case, keeping the information on the images meeting the previous version of the sorting rule allows both of the images meeting the sorting rule before the modification and the images meeting the sorting rule after the modification to be displayed. Accordingly, the user can check whether the sorting rule after the modification is appropriate or not while comparing the images.

Furthermore, in the present embodiment, the list screen is generated such that the user can identify the images meeting the previous version of the sorting rule and the images meeting the latest version of the sorting rule. Accordingly, the user can identify which images are the images meeting the latest version also in the case where the images meeting the latest version of the sorting rule and the images meeting the previous version of the sorting rule are collectively displayed. Thus, for example, the user can easily check whether the sorting rule after the modification is an intended sorting rule or not.

Note that, although the thumbnails representing the images meeting the previous version of the sorting rule are explained to be displayed in a grayed-out manner, display in a grayed-out manner is merely an example. It is only necessary that, in S809 and S810, the thumbnails representing the images meeting the latest version of the sorting rule and the thumbnails representing the images meeting the previous version of the sorting rule are processed to be displayed in a distinguishable manner. For example, the size of the thumbnails of the images meeting the latest version of the sorting rule may be varied from the size of the thumbnails of the images meeting the previous version of the sorting rule. Alternatively, instead of varying the display of the thumbnails, the thumbnails may be distinguishable from one another on the list screen. For example, a line may be displayed at a border between the thumbnails of the images meeting the latest version of the sorting rule and the thumbnails of the images meeting the previous version of the sorting rule. Display of the thumbnails of the images meeting the latest version of the sorting rule and display of the thumbnails of the images meeting the previous version of the sorting rule may each be switched between display and non-display.

Moreover, although the thumbnails of the images are explained to be displayed on the list screen in the present embodiment, icons representing the images may be displayed. Also in this case, the list screen may be displayed with a display format of the icons of the images meeting the latest version of the sorting rule varied from a display format of the icons of the images meeting the previous version of the sorting rule.

Furthermore, the configuration may be such that the user can select the thumbnails from the list screen displaying the sorting result. Moreover, the image management apparatus 101 may perform a process of saving the files of the images represented by the thumbnails selected by the user to a predetermined folder, a process of transmitting the files to the external apparatuses 102, and the like.

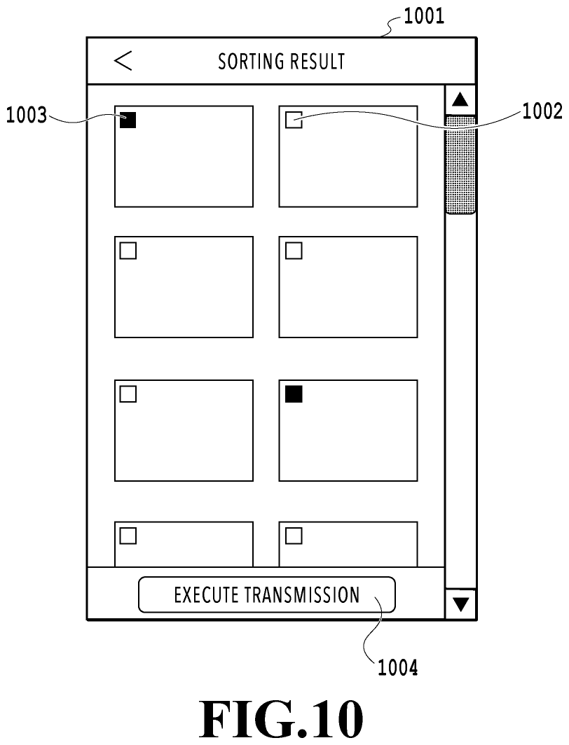

FIG. 10 is a diagram illustrating an example of a screen in which the list screen of FIG. 9 is set to a state where the thumbnails can be selected. A check box 1002 that allows the user to select the thumbnail is superimposed on an upper-right portion of each thumbnail. The check box of the thumbnail selected by the user is changed to a check box 1003 indicating selection. FIG. 10 is also assumed to be a screen for selecting the thumbnails of the images to be transmitted to the external apparatuses 102. Accordingly, in the case where a transmission execution button 1004 is pressed, the files of the images represented by the selected thumbnail are processed to be transmitted to the external apparatuses 102.

The list screen as in FIG. 10 whose purpose is to allow image selection by the user does not have to present the information on the version of the sorting rule according to which the images are sorted to the user in some cases, unlike the screen of FIG. 9 that allows the user to check whether the desired images are selected as a result of the sorting process. Accordingly, in the screen as illustrated in FIG. 10 whose purpose is not to allow the checking of the sorting result by the user, the thumbnails of the images meeting the latest version of the sorting rule and the thumbnails of the images meeting the previous version of the sorting rule may be displayed in the same display format.

Moreover, for example, there is a case where the thumbnails of the images selected according to the sorting rules with the rule IDs of different values are displayed in the list screen. Also in such a case, the thumbnails of the images meeting the first sorting rule and the thumbnails of the images meeting the second sorting rule different from the first sorting rule may be displayed in varying display formats.

Furthermore, in the present embodiment, the sorting rules, the sorting results, and the like are explained to be managed in a table format. The method of managing information is not limited to the table format, and may be managed in other formats such as, for example, JSON format.

### Embodiment 2

In Embodiment 1, explanation is given of the method in which, in the case where the sorting process according to the designated sorting rule is executed and then the value of the sorting item in the sorting rule is modified, the sorting method is performed only on the added images according to the sorting rule after the modification. Assume a situation where the user modifies the sorting rule as a trial, executes the sorting process according to the sorting rule after the modification, and checks that the sorting result of this sorting process is a result intended by the user. In this situation, there is a case where the user desires to set the images already subjected to the sorting process also as targets of the sorting process according to the sorting rule after the modification. Accordingly, in the present embodiment, explanation is given of a method in which the sorting process is performed also on the already-sorted images according to the sorting rule after the modification. The present embodiment is explained while focusing on differences from Embodiment 1. Portions that are not particularly clearly described are the same configurations and processes as those of Embodiment 1.

### [Regarding Sorting Result Table]

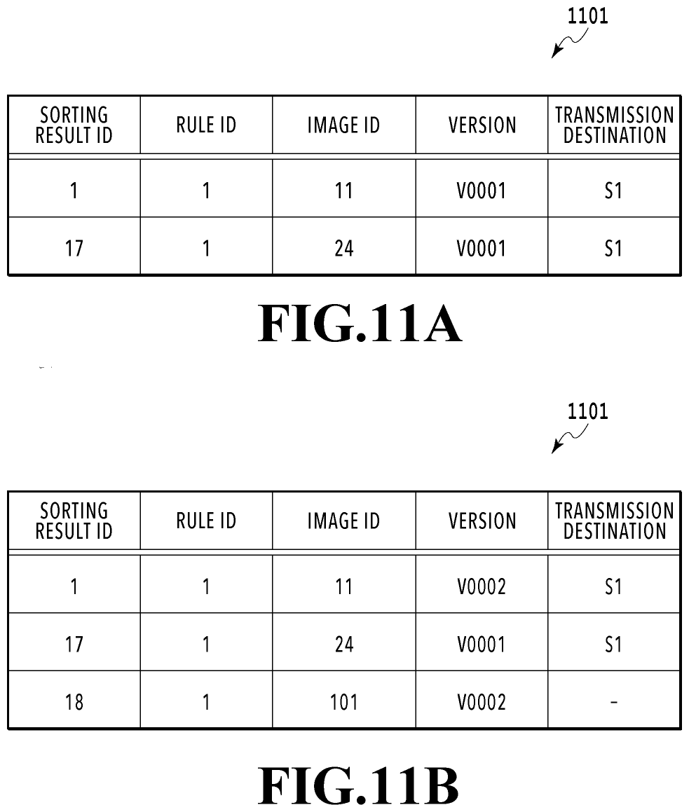

FIGS. 11A and 11B are diagrams illustrating an example of a sorting result management table of the present embodiment. Unlike the sorting result management table 701 of FIG. 7A, in the sorting result management table 1101 of the present embodiment, a value indicating a transmission destination is associated in each row including the image ID of the transmitted image. For example, in the case where a thumbnail is selected and an image is transmitted in a screen as in FIG. 10, the transmission control unit 307 registers information on the transmission destination in a “transmission destination” column in the row including the image ID indicating the transmitted image in the sorting result management table 1101. The information on the transmission destination may be an ID or a name indicating the transmission destination, or a value of a flag indicating whether the image is transmitted or not. For example, “−” is held in the “transmission destination” column in the row including the image ID indicating the not-transmitted image.

### [Flow of Resorting Process]

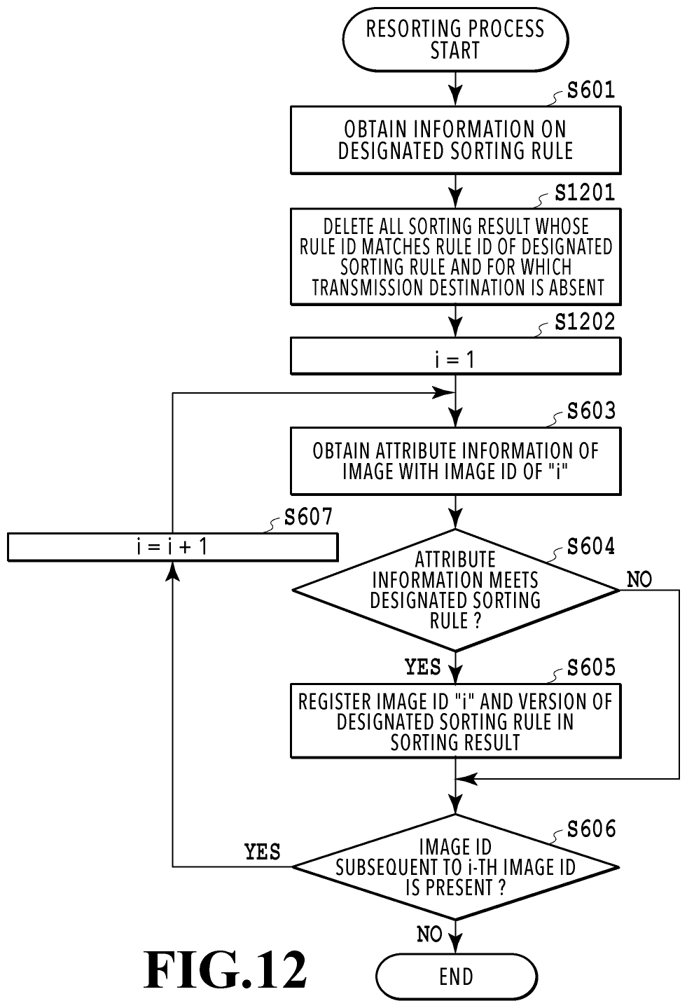

FIG. 12 is a flowchart of the present embodiment for explaining details of the sorting process according to the designated sorting rule. The flowchart of FIG. 12 is a flowchart for explaining a sorting process (resorting process) executed after execution of the sorting process according to the designated sorting rule in the past. In the case where the sorting process is executed for the first time, the sorting process according to the flowchart of FIG. 6 is performed also in the present embodiment.

The flowchart of FIG. 12 is the flowchart of the sorting process of FIG. 6 to which new steps are added. Accordingly, steps in the flowchart of FIG. 12 that are the same as the steps in the flowchart of FIG. 6 are denoted by the same reference numerals also in FIG. 12. Accordingly, steps different from those in the flowchart of FIG. 6 are explained in explanation of the flowchart of FIG. 12.

In S1201, the CPU 201 deletes a deletion target sorting result (row), from the sorting results (rows) included in the sorting result management table 1101. The deletion target sorting result is a sorting result (row) in which the value of the rule ID indicating the designated sorting rule is held in the “rule ID” column and “−” indicating no transmission is held in the “transmission destination” column.

The sorting result management table 1101 of FIG. 11A illustrates the sorting result management table after deletion of all deletion target sorting results. Since the sorting results (rows) with the sorting result IDs of 2 to 16 are deleted, the sorting result management table 1101 of FIG. 11A is in a state where there are no sorting results with the sorting result IDs of 2 to 16.

A reason why the sorting results relating to the transmitted images are not deleted in S1201 is that the transmitted images are assumed to be images important to the user. The sorting results (rows) not deleted in S1201 are not limited to the sorting results of the transmitted images, and the configuration may be such that sorting results that satisfy a condition set by the user are not deleted. For example, in S1201, all rows in which the value of the rule ID indicating the designated sorting rule is held in the “rule ID” column may be deleted from the sorting result management table 1101. Moreover, the configuration may be such that the step of S1201 is omitted and the sorting results are not deleted from the sorting result management table 1101 also in the case where the resorting process is performed.

In S1202, the CPU 201 sets the variable i to 1. The following steps of S603 to S607 are a loop process in which an image corresponding to the variable i among the images of the user managed in the current image management table 401 is set as a target of the sorting process in which the CPU 201 determines whether the image meets the latest version of the sorting rule or not. In the present embodiment, in S1202, the CPU 201 sets the variable i to 1 such that all images managed in the image management table 401 are set as the sorting targets. Specifically, unlike in Embodiment 1, the sorting process is performed on all images including the already-sorted images.

In the case where the CPU 201 registers the sorting result in the sorting result management table 1101 in S605 of FIG. 12, the sorting result that holds the value of the identical image ID is present in some cases. In this case, in S605 of FIG. 12, the version of the sorting rule in the sorting result holding the value of the identical image ID is updated to the value of the latest version.

For example, assume that the sorting result management table 1101 of FIG. 11A is saved, and the CPU 201 determines that the image with the image ID of “11” meets the sorting rule with the rule ID of “1” whose version is “V0002”. In this case, the version in the row of the sorting result ID in which “11” is held in the sorting result management table 1101 is updated to “V0002” as illustrated in FIG. 11B.

Note that only some of the images managed in the image management table 401 may be set as the targets of the resorting process. In this case, the configuration may be such that only the sorting results in which the images ID indicating the images being the resorting process targets are held are deleted in S1201, and the processes of S603 to S607 are performed only for the image IDs of the resorting process target images.

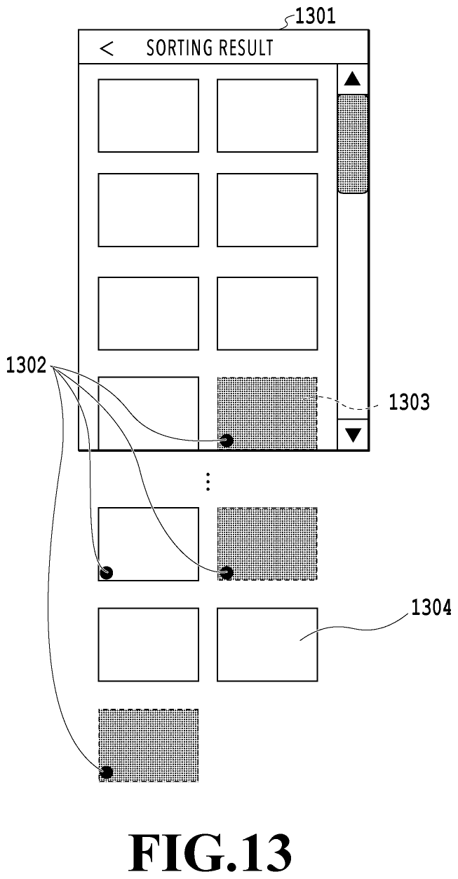

FIG. 13 is a diagram illustrating a list screen of the present embodiment for presenting the sorting results to the user. Thumbnails included in the list screen 1301 are different from those in the list screen 901 of Embodiment 1 illustrated in FIG. 9, and the list screen 1301 is generated such that an icon 1302 indicating that the image has been already transmitted is appended to each of the thumbnails of the images already transmitted to the external apparatuses 102.

A thumbnail 1303 illustrates a thumbnail of an image that meets the previous version of the sorting rule but does not meet the latest version of the sorting rule. Since this image is the already-transmitted image, this image is not deleted, and the thumbnail thereof is displayed in a grayed-out manner. A thumbnail 1304 illustrates a thumbnail of an image that does not meet the previous version or that is not transmitted. Since this image is an image meeting the latest version of the sorting rule, the thumbnail thereof is normally displayed.

In the case where the resorting process is executed on the images including the already-sorted images, the thumbnails of the images that meet the previous version of the sorting rule but do not meet the latest version of the sorting rule are displayed in a grayed-out manner as described above. Accordingly, in the present embodiment, it is possible to reduce the work by the user checking whether the modified sorting rule is an unintended rule in the case where the resorting process is performed on the images including the already-sorted images.

Note that the configuration may be such that, for the image that meet the previous version of the sorting rule but does not meet the latest version of the sorting rule, the user may be notified of a reason why the image does not meet the latest version.

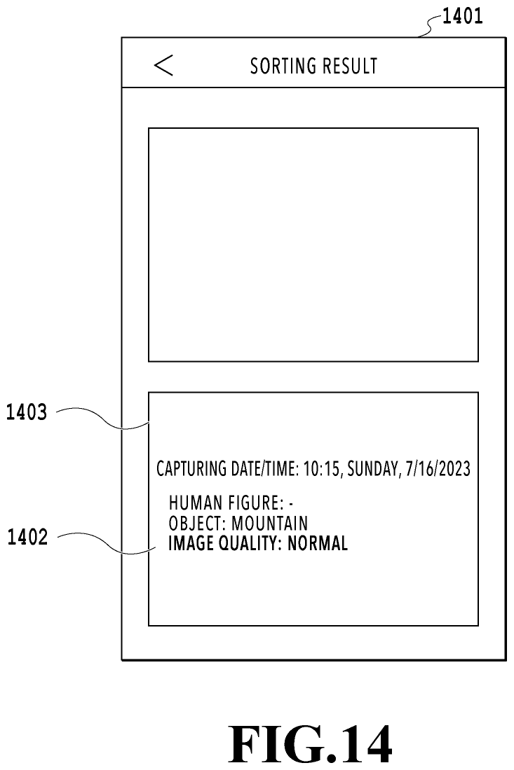

FIG. 14 is a diagram illustrating an example of a list screen that explains the reason why the image does not meet the latest version of the sorting rule, to the user. A thumbnail 1403 in the list screen 1401 is a thumbnail selected by the user, and the CPU 201 performs control such that attribute information 1402 of the image represented by the selected thumbnail is added and displayed in the selected thumbnail. Moreover, the thumbnail 1403 is assumed to be a thumbnail of the image that meets the previous version of the sorting rule but does not meet the latest version of the sorting rule. The CPU 201 performs control such that the attribute information of “image quality” that does not meet the latest version of the sorting rule is displayed in a highlighted manner in the attribute information 1402 added to the thumbnail 1403 as described above. The attribute information that does not meet the latest version of the sorting rule may be displayed in a display format different from that of the other attribute information as described above.

Note that, in the case where the resorting process is performed, the resorting process may be switched between a mode in which the resorting process is performed according to the flowchart of FIG. 6 and a mode in which the resorting process is performed according to the flowchart of FIG. 12, depending on a user instruction.

### OTHER EMBODIMENTS

The methods explained in the above-mentioned embodiments may be implemented also by using, for example, a system, an apparatus, a method, a program, a recording medium (storage medium), or the like. Specifically, the methods may be applied to a system formed of multiple devices (for example, a host computer, an interface device, an imaging apparatus, a web application, and the like) or may be applied to an apparatus formed of one device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An information processing apparatus that manages captured images of a user, the information processing apparatus comprising:
a selection unit configured to select the captured image meeting a specific condition from among the managed captured images;
a modification unit configured to modify the specific condition based on an instruction by a user; and
a display control unit configured to perform a process of displaying a list screen of the captured image selected as meeting the specific condition, wherein
the list screen is displayed such that the captured image selected as meeting the specific condition before the modification and the captured image selected as meeting the specific condition after the modification are identifiable.

2. The information processing apparatus according to claim 1, wherein, in the list screen, a thumbnail of the captured image selected as meeting the specific condition is displayed as the captured image, and the thumbnail of the captured image selected as meeting the specific condition before the modification is displayed in a display format varying from a display format of the thumbnail of the captured image selected as meeting the specific condition after the modification.

3. The information processing apparatus according to claim 2, wherein, in the list screen, the thumbnail of the captured image selected as meeting the specific condition before the modification is displayed in a color varying from a color of the thumbnail of the captured image selected as meeting the specific condition after the modification.

4. The information processing apparatus according to claim 1, further comprising
a first management unit configured to manage information on the specific condition, wherein
the information on the specific condition managed by the first management unit includes a value indicating a version of the specific condition.

5. The information processing apparatus according to claim 4, further comprising:
a second management unit configured to manage information on the captured image selected as meeting the specific condition, wherein
the information on the captured image selected as meeting the specific condition includes the value indicating the version of the specific condition at a point where the captured image is selected as meeting the specific condition.

6. The information processing apparatus according to claim 5, wherein, in a case where the value indicating the version included in the information on a first captured image managed by the second management unit varies from the value indicating the version of the specific condition managed by the first management unit, the display control unit displays the first captured image on the list screen as the captured image selected as meeting the specific condition before the modification.

7. The information processing apparatus according to claim 1, wherein the selection unit selects the captured image meeting the specific condition after the modification from among the captured images for which determination of whether the captured image meets the specific condition before the modification is not performed.

8. The information processing apparatus according to claim 5, wherein, in a case where a first captured image selected as meeting the specific condition before the modification is also selected as meeting the specific condition after the modification, the second management unit updates the value indicating the version included in the information on the first captured image.

9. The information processing apparatus according to claim 5, further comprising:
a transmission control unit configured to perform a process of transmitting the captured image selected from list screen, wherein
the information on the captured image selected as meeting the specific condition that is managed by the second management unit further includes a value indicating whether the captured image is the transmitted captured image or not.

10. The information processing apparatus according to claim 9, wherein, in a case where the selection unit performs a process of selecting the captured image meeting the specific condition after the modification, the second management unit deletes the information on the captured image that is not transmitted, and
the display control unit displays, on the list screen, a thumbnail of the captured image whose information is managed by the second management unit.

11. The information processing apparatus according to claim 10, wherein, in the case where the captured image not meeting the specific condition after the modification is designated by a user from the list screen, the display control unit displays, in a highlighted manner, a piece of attribute information of the designated captured image, the piece of attribute information not meeting the specific condition after the modification.

12. The information processing apparatus according to claim 1, further comprising:
a third management unit configured to manage information on the managed captured images, wherein
the information on the captured images managed by the third management unit includes attribute information of the captured images, and
the selection unit selects the captured image whose attribute information satisfies the specific condition.

13. The information processing apparatus according to claim 1, wherein the specific condition is formed of a plurality of items used in the selection, and
the selection unit selects the captured image meeting all of values set in the plurality of items, as the captured image meeting the specific condition.

14. The information processing apparatus according to claim 1, wherein the specific condition is formed a plurality of items used in the selection, and
the modification unit modifies a value of at least one of the plurality of items based on an instruction by a user.

15. An information processing method of managing captured images of a user, the information processing method comprising:
selecting the captured image meeting a specific condition from among the managed captured images;
modifying the specific condition based on an instruction by a user; and
performing a process of displaying a list screen of the captured image selected as meeting the specific condition,
wherein the list screen is displayed such that the captured image selected as meeting the specific condition before the modification and the captured image selected as meeting the specific condition after the modification are identifiable.

16. A non-transitory computer readable storage medium storing a program which causes a computer to perform an image processing method of managing captured images of a user, the information processing method comprising:
selecting the captured image meeting a specific condition from among the managed captured images;
modifying the specific condition based on an instruction by a user; and
performing a process of displaying a list screen of the captured image selected as meeting the specific condition,
wherein the list screen is displayed such that the captured image selected as meeting the specific condition before the modification and the captured image selected as meeting the specific condition after the modification are identifiable.
